(19) United States
(12) Patent Application Publication
(10) Pub. No.: US 2021/0135566 A1
(43) Pub. Date: May 6, 2021

(54) VOLTAGE CONVERTER AND OPERATING METHOD THEREOF

(71) Applicant: ASUSTeK COMPUTER INC., Taipei (TW)

(72) Inventors: Chun-San LIN, TAIPEI (TW); Ming-Ting TSAI, TAIPEI (TW); Wei-Gen CHUNG, TAIPEI (TW); Hsi-Ho HSU, TAIPEI (TW); Chen-Hao YU, TAIPEI (TW)

(21) Appl. No.: 16/984,240

(22) Filed: Aug. 4, 2020

(30) Foreign Application Priority Data
Nov. 1, 2019 (TW) 108139805

(51) Int. Cl. H02M 3/07; H02M 1/00

(52) U.S. Cl. CPC H02M 3/07; H02M 2001/0048; H02M 1/00

(57) ABSTRACT

A voltage converter is provided. The voltage converter includes a charge pump and a switching circuit. The charge pump includes an input capacitor, where two ends of the input capacitor are electrically connected to an input end and a ground end respectively. The switching circuit includes a first switch, a second switch, a third switch, and a fourth switch, and these switches are connected in series. The first switch is electrically connected to the input end, the fourth switch is electrically connected to the ground end, a capacitor is connected in parallel with the second switch and the third switch, and an output end is electrically connected between the second switch and the third switch.

### CROSS-REFERENCE TO RELATED APPLICATION

This application claims the priority benefit of Taiwan Application Serial No. 108139805, filed on Nov. 1, 2019. The entirety of the above-mentioned patent application is hereby incorporated by reference herein and made a part of specification.

### BACKGROUND OF THE INVENTION

### Field of the Invention

The disclosure relates to a converter and a method, and in particular, to a voltage converter and an operating method thereof.

### Description of the Related Art

Generally, a voltage converter can be a booster circuit and/or a buck circuit. In an embodiment, the buck circuit is mainly of a buck architecture or a charge pump architecture. The charge pump architecture controls, by using a switch element, voltage of a connected capacitor, to supply power to a rear load end, so that the loss is less than that of the buck architecture but with higher efficiency. However, an input capacitor in the charge pump architecture accounts for a larger part of overall power loss.

### BRIEF SUMMARY OF THE INVENTION

The disclosure provides a voltage converter and an operating method thereof. The voltage converter provided in the disclosure includes a charge pump and a switching circuit. The charge pump includes an input capacitor, where two ends of the input capacitor are electrically connected to an input end and a ground end respectively. The switching circuit includes a first switch, a second switch, a third switch, and a fourth switch, and these switches are connected in series. The first switch is electrically connected to the input end, the fourth switch is electrically connected to the ground end, a capacitor is connected in parallel with the second switch and the third switch, and an output end is electrically connected between the second switch and the third switch.

In the disclosure, in an embodiment of an operating method of a buck converter, the buck converter includes a charge pump and a switching circuit that are electrically connected to each other, and the charge pump includes an input capacitor. The operating method includes: controlling the switching circuit and the charge pump, and enabling a current path of the charge pump to pass through the switching circuit and to avoid the input capacitor; and performing buck conversion through the charge pump.

To sum up, the voltage converter and the operating method thereof in the disclosure reduce loss caused by a body of the input capacitor, thereby improving overall efficiency to resolve a thermal problem.

The disclosure will be described in detail through embodiments, and a further explanation of the technical solutions of the disclosure will be provided.

### BRIEF DESCRIPTION OF THE DRAWINGS

To make the foregoing and other objectives, features, advantages, and embodiments of the disclosure more comprehensible, descriptions of the accompanying drawings are as follows:

FIG. 1 is a circuit diagram of a voltage converter according to an embodiment of the disclosure;

FIG. 2 is a sequence diagram of a voltage converter in an operation according to an embodiment of the disclosure;

FIG. 3 is a schematic diagram of a current path of a voltage converter in a first state according to an embodiment of the disclosure;

FIG. 4 is a schematic diagram of a current path of a voltage converter in a second state according to an embodiment of the disclosure; and

FIG. 5 is a flowchart of an operating method of a voltage converter according to an embodiment of the disclosure.

### DETAILED DESCRIPTION OF THE EMBODIMENTS

To make the description of the disclosure more thorough and complete, reference may be made to the accompanying drawings and the various embodiments described below. The same number in the drawings represents the same or similar element. On the other hand, well-known components and steps are not described in the embodiments to avoid unnecessarily limiting the disclosure.

In the embodiments and the claims, the term “connection” generally refers to an indirect coupling of an element to another element through other elements, or a direction connection of an element to another element without passing through other elements.

In the embodiments and the claims, unless an article is specifically defined in the disclosure, “a/an” and “the” may generally refer to a single or a plural.

The terms “about”, “approximately” or “roughly” used in the disclosure are used to describe any quantity that can vary slightly, but which does not change its nature. Unless otherwise specified in the embodiment, an error range for numeric values modified by “about”, “approximately” or “roughly” is generally within 20 percent, relatively preferably within 10 percent and more preferably within 5 percent.

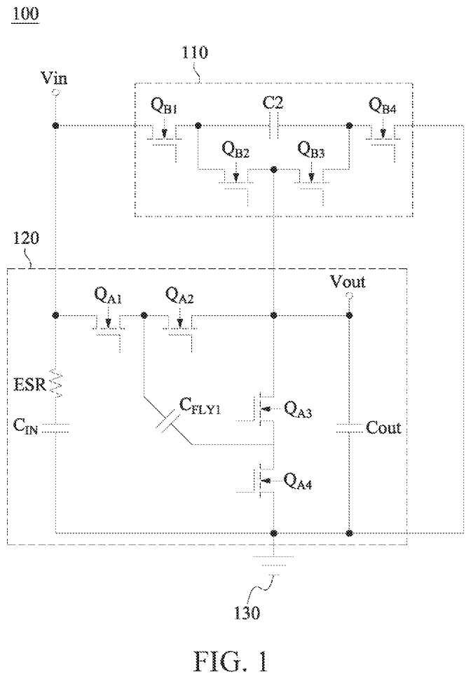

FIG. 1 is a circuit diagram of a voltage converter 100 according to an embodiment of the disclosure. As shown in FIG. 1, the voltage converter 100 mainly includes a charge pump 120 and a switching circuit 110. The switching circuit 110 is electrically connected to the charge pump 120. When in use, a controller (which is not shown) controls the switching circuit 110 and the charge pump 120, and enables a current path of the charge pump 120 to pass through the switching circuit 110 and to avoid an input capacitor C_{IN} in the charge pump 120, so that the input capacitor C_{IN} is merely used to perform a function of voltage stabilization, thereby performing buck conversion through the charge pump 120. A large current does not pass through the input capacitor C_{IN}, so that the loss caused by the input capacitor C_{IN} is reduced and overall efficiency for resolve thermal problems are improved.

As shown in FIG. 1, two ends of the input capacitor C_{IN} are electrically connected to an input end Vin and a ground end 130 respectively. The switching circuit 110 includes a first switch Q_{B1}, a second switch Q_{B2}, a third switch Q_{B3}, a fourth switch Q_{B4}, and a capacitor C2. The first switch Q_{B1}, the second switch Q_{B2}, the third switch Q_{B3}, and the fourth switch Q_{B4} are connected in series. The first switch Q_{B1} is electrically connected to the input end Vin, the fourth switch Q_{B4} is electrically connected to the ground end 130, the capacitor C2 is connected in parallel with the second switch Q_{B2} and the third switch Q_{B3}, and an output end Vout is electrically connected between the second switch Q_{B2} and the third switch Q_{B3}.

Specifically, the charge pump 120 further includes a fifth switch Q_{A1}, a sixth switch Q_{A2}, a seventh switch Q_{A3}, an eighth switch Q_{A4}, a flying capacitor C_{FLY1}, and an output capacitor Cout. In an architecture, the fifth switch Q_{A1}, the sixth switch Q_{A2}, the seventh switch Q_{A3}, and the eighth switch Q_{A4} are connected in series, where the fifth switch Q_{A1} is electrically connected to the input end Vin, the eighth switch Q_{A4} is electrically connected to the ground end 130, the input capacitor C_{IN} is connected in parallel with the fifth switch Q_{A1}, the sixth switch Q_{A2}, the seventh switch Q_{A3}, and the eighth switch Q_{A4}. The flying capacitor C_{FLY1} is connected in parallel with the sixth switch Q_{A2} and the seventh switch Q_{A3}, where the output end Vout is electrically connected between the sixth switch Q_{A2} and the seventh switch Q_{A3}. The output capacitor Cout is connected in parallel with the seventh switch Q_{A3} and the eighth switch Q_{A4}. In an embodiment, capacitance of the input capacitor C_{IN} (such as a polymer capacitor) is much larger than capacitance of the capacitor C2, the flying capacitor C_{FLY1}, and the output capacitor Cout, where the input capacitor C_{IN} includes an equivalent series resistance ESR.

In the switching circuit 110, one end of the first switch Q_{B1} is electrically connected to the input end Vin; another end of the first switch Q_{B1} is electrically connected to one end of the second switch Q_{B2} and one end of the capacitor C2; another end of the second switch Q_{B2} is electrically connected to one end of the third switch Q_{B3} and the output end Vout; another end of the third switch Q_{B3} is electrically connected to one end of the fourth switch Q_{B4} and another end of the capacitor C2; and another end of the fourth switch Q_{B4} is electrically connected to the ground end 130.

In the charge pump 120, one end of the fifth switch Q_{A1} is electrically connected to the input end Vin and one end of the input capacitor C_{IN}; another end of the fifth switch Q_{A1} is electrically connected to one end of the sixth switch Q_{A2} and one end of the flying capacitor C_{FLY1}; another end of the sixth switch Q_{A2} is electrically connected to one end of the seventh switch Q_{A3}, another end of the second switch Q_{B2}, the one end of the third switch Q_{B3}, and the output end Vout; another end of the seventh switch Q_{B3} is electrically connected to one end of the eighth switch Q_{B4} and another end of the flying capacitor C_{FLY1}; and another end of the eighth switch Q_{B4} is electrically connected to another end of the input capacitor C_{IN} and the ground end 130. One end of the output capacitor Cout is electrically connected to the output end Vout, and another end of the output capacitor Cout is electrically connected to the ground end 130.

In an embodiment of the disclosure, each of the first switch Q_{B1}, the second switch Q_{B2}, the third switch Q_{B3}, the fourth switch Q_{B4}, the fifth switch Q_{A1}, the sixth switch Q_{A2}, the seventh switch Q_{A3}, or the eighth switch Q_{A4} is an electronic switch (such as a metal-oxide semiconductor). In an embodiment, the metal-oxide semiconductor is an N-type metal-oxide semiconductor.

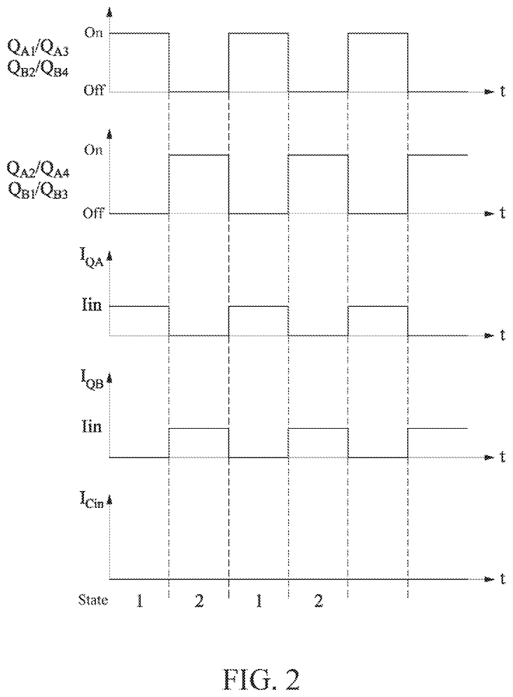

FIG. 2 is a sequence diagram of a voltage converter 100 in an operation according to an embodiment of the disclosure. As shown in FIG. 2, an input current Iin is a current flowing out from the input end Vin, a current I_{QA} represents a current flowing directly from the input end Vin to the charge pump 120, and a current I_{QB} represents a current flowing directly from the input end Vin to the switching circuit 110. A current I_{Cin} represents a current passing through the input capacitor C_{IN}.

When the second switch Q_{B2}, the fourth switch Q_{B4}, the fifth switch Q_{A1} and the seventh switch Q_{A3} are conducted (that is, turned on), and the first switch Q_{B1}, the third switch Q_{B3}, the sixth switch Q_{A2}, and the eighth switch Q_{A4} are turned off, a first state 1 is defined.

Otherwise, when the second switch Q_{B2}, the fourth switch Q_{B4}, and the fifth switch Q_{A1} and the seventh switch Q_{A3} are turned off, and the first switch Q_{B1}, the third switch Q_{B3}, the sixth switch Q_{A2} and the eighth switch Q_{A4} are conducted (that is, turned on), a second state 2 is defined.

As shown in FIG. 2, no matter in the first state 1 or the second state 2, the current I_{Cin} passing through the input capacitor C_{IN} is zero.

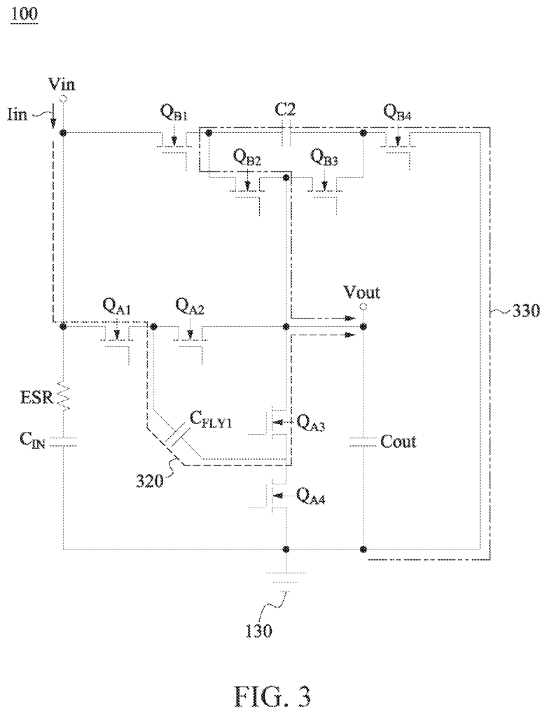

Referring to FIG. 2 and FIG. 3 for a further explanation of the current path of the foregoing voltage converter 100 in the first state 1, FIG. 3 is a schematic diagram of the current path of the voltage converter 100 in the first state 1 according to an embodiment of the disclosure. As shown in FIG. 3, when the second switch Q_{B2}, the fourth switch Q_{B4}, and the fifth switch Q_{A1} and the seventh switch Q_{A3} are conducted (that is, turned on), and the first switch Q_{B1}, the third switch Q_{B3}, the sixth switch Q_{A2}, and the eighth switch Q_{A4} are turned off, a current path 320 of the input current IN passes sequentially from the input end Vin through the fifth switch Q_{A1}, the flying capacitor C_{FLY1}, and the seventh switch Q_{A3} to one end of the output capacitor Cout (that is, the output end Vout), where the current I_{QA} on the current path 320 is shown in FIG. 3. A current path 330 passes sequentially from another end of the output capacitor Cout through the fourth switch Q_{B4}, the capacitor C2, and the second switch Q_{B2} to the output end Vout.

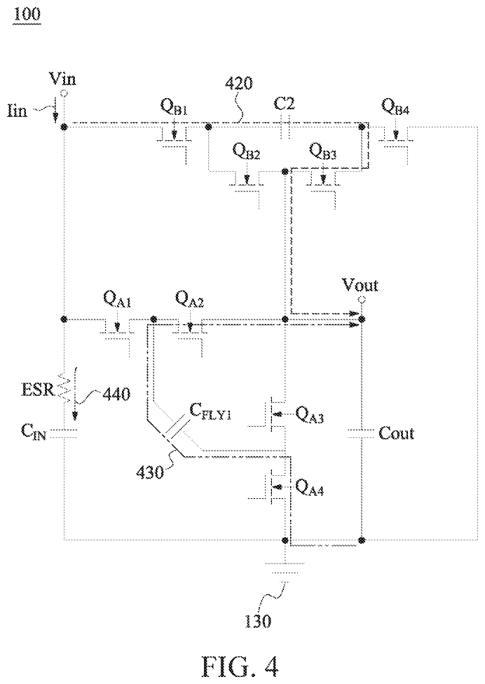

Referring to FIG. 2 and FIG. 4 for a further explanation of the current path of the voltage converter 100 in the second state 2, FIG. 4 is a schematic diagram of the current path of the voltage converter 100 in the second state 2 according to an embodiment of the disclosure. As shown in FIG. 4, when the second switch Q_{B2}, the fourth switch Q_{B4}, the fifth switch Q_{A1}, and the seventh switch Q_{A3} are turned off, and the first switch Q_{B1}, the third switch Q_{B3}, the sixth switch Q_{A2} and the eighth switch Q_{A4} are conducted (that is, turned on), a current path 420 of the input current IN passes sequentially from the input end Vin through the first switch Q_{B1}, the capacitor C2, and the third switch Q_{B3} to one end of the output capacitor Cout (that is, the output end Vout), where the current I_{QB} on the current path 420 is shown in FIG. 2. A current path 430 passes sequentially from another end of the output capacitor through the eighth switch Q_{A4}, the flying capacitor C_{FLY1}, and the sixth switch Q_{A2} to the output end Vout. As shown in FIG. 2 and FIG. 4, in the second state 2, the currents I_{Cin} on a current path 440 is zero.

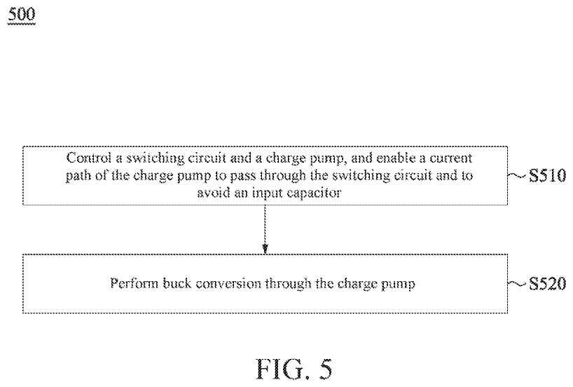

Referring to FIG. 1 to FIG. 5 for a further explanation of an operating method of the foregoing voltage converter 100, FIG. 5 is a flowchart of the operating method 500 of the voltage converter 100 according to an embodiment of the disclosure. As shown in FIG. 5, the operating method 500 includes step S510 and step S520 (It should be learned that, unless otherwise specified, a sequence of the steps mentioned in this embodiment are adjusted according to actual requirements, or even the steps are performed simultaneously or partially simultaneously). In practice, the operating method 500 is implemented by a controller by controlling the voltage converter 100.

Step S510: Control the switching circuit 110 and the charge pump 120, and enable the current path of the charge pump 120 to pass through the switching circuit 110 and to avoid passing through the input capacitor CN. Step S520: Perform buck conversion through the charge pump 120.

In the operating method 500, when the second switch Q_{B2}, the fourth switch Q_{B4}, the fifth switch Q_{A1}, and the seventh switch Q_{A3} are conducted, the first switch Q_{B1}, the third switch Q_{B3}, the sixth switch Q_{A2}, and the eighth switch Q_{A4} are turned off, so that the current path 320 of the input current IN passes sequentially from the input end Vin through the fifth conductor switch Q_{A1}, the flying capacitor C_{FLY1}, and the seventh switch Q_{A3} to one end of the output capacitor Cout (that is, the output end Vout), and the current path 330 passes sequentially from another end of the output capacitor Cout through the fourth switch Q_{B4}, the capacitor C2, and the second switch Q_{B2} to the output end Vout.

Otherwise, in the operating method 500, when the first switch Q_{B1}, the third switch Q_{B3}, the sixth switch Q_{A2}, and the eighth switch Q_{A4} are conducted, the second switch Q_{B2}, the fourth switch Q_{B4}, the fifth switch Q_{A1}, and the seventh switch Q_{A3} are turned off, so that the current path 420 of the input current IN passes sequentially from the input end Vin through the first switch Q_{B1}, the capacitor C2, and the third switch Q_{B3} to one end of the output capacitor Cout (that is, the output end Vout), and the current path 430 passes sequentially from another end of the output capacitor through the eighth switch Q_{A4}, the flying capacitor C_{FLY1}, and the sixth switch Q_{A2} to the output end Vout.

To sum up, the voltage converter and the operating method thereof in the disclosure reduce loss caused by a body of the input capacitor, thereby improving overall efficiency to resolve a thermal problem.

Although the disclosure is described with reference to the above embodiments, the embodiments are not intended to limit the disclosure. Any person skilled in the art may make variations and improvements without departing from the spirit and scope of the disclosure. Therefore, the protection scope of the disclosure should be subject to the appended claims.

What is claimed is:

1. A voltage converter, comprising:
a charge pump, comprising an input capacitor, wherein two ends of the input capacitor are electrically connected to an input end and a ground end respectively; and
a switching circuit, comprising:
a first switch, a second switch, a third switch, and a fourth switch that are connected in series, wherein the first switch is electrically connected to the input end, and the fourth switch is electrically connected to the ground end; and
a capacitor, connected in parallel with the second switch and the third switch, wherein an output end is electrically connected between the second switch and the third switch.

2. The voltage converter according to claim 1, wherein the charge pump further comprises:
a fifth switch, a sixth switch, a seventh switch, and an eighth switch that are connected in series, wherein the fifth switch is electrically connected to the input end, the eighth switch is electrically connected to the ground end; and the input capacitor is connected in parallel with the fifth switch, the sixth switch, the seventh switch, and the eighth switch;
a flying capacitor, connected in parallel with the sixth switch and the seventh switch, wherein the output end is electrically connected between the sixth switch and the seventh switch; and
an output capacitor, connected in parallel with the seventh switch and the eighth switch.

3. The voltage converter according to claim 2, wherein one end of the first switch is electrically connected to the input end; another end of the first switch is electrically connected to one end of the second switch and one end of the capacitor; another end of the second switch is electrically connected to one end of the third switch and the output end; another end of the third switch is electrically connected to one end of the fourth switch and another end of the capacitor; and another end of the fourth switch is electrically connected to the ground end.

4. The voltage converter according to claim 3, wherein one end of the fifth switch is electrically connected to the input end and one end of the input capacitor; another end of the fifth switch is electrically connected to one end of the sixth switch and one end of the flying capacitor; another end of the sixth switch is electrically connected to one end of the seventh switch, the another end of the second switch, the end of the third switch and the output end; another end of the seventh switch is electrically connected to one end of the eighth switch and another end of the flying capacitor; and another end of the eighth switch is electrically connected to another end of the input capacitor and the ground end.

5. The voltage converter according to claim 2, wherein one end of the output capacitor is electrically connected to the output end, and another end of the output capacitor is electrically connected to the ground end.

6. The voltage converter according to claim 2, wherein each of the first switch, the second switch, the third switch, the fourth switch, the fifth switch, the sixth switch, the seventh switch, and the eighth switch is a metal-oxide semiconductor.

7. The voltage converter according to claim 6, wherein the metal-oxide semiconductor is an N-type metal-oxide semiconductor.

8. An operating method of a voltage converter, wherein the voltage converter comprises a charge pump and a switching circuit that are electrically connected to each other, the charge pump comprises an input capacitor, and the operating method comprises:
controlling the switching circuit and the charge pump, and enabling a current path of the charge pump to pass through the switching circuit and to avoid the input capacitor; and
performing buck conversion through the charge pump.

9. The operating method according to claim 8, wherein the switching circuit comprises a capacitor and a first switch, a second switch, a third switch, and a fourth switch that are connected in series; the first switch is electrically connected to an input end; the fourth switch is electrically connected to a ground end; the capacitor is connected in parallel with the second switch and the third switch; an output end is electrically connected between the second switch and the third switch; the charge pump further comprises an output capacitor, a flying capacitor and a fifth switch, a sixth switch, a seventh switch, and an eighth switch that are connected in series; the fifth switch is electrically connected to the input end; the eighth switch is electrically connected to the ground end; the input capacitor is connected in parallel with the fifth switch, the sixth switch, the seventh switch, and the eighth switch; the flying capacitor is connected in parallel with the sixth switch and the seventh switch; the output end is electrically connected between the sixth switch and the seventh switch; the output capacitor is connected in parallel with the seventh switch and the eighth switch; one end of the output capacitor is electrically connected to the output end; another end of the output capacitor is electrically connected to the ground end; and the operating method further comprises:
when the second switch, the fourth switch, the fifth switch, and the seventh switch are conducted, turning off the first switch, the third switch, the sixth switch, and the eighth switch, so that the current path passes sequentially from the input end through the fifth conductor switch, the flying capacitor, and the seventh switch to the end of the output capacitor, and passes sequentially from the another end of the output capacitor through the fourth switch, the capacitor, and the second switch to the output end.

10. The operating method according to claim 9, further comprising:
when the first switch, the third switch, the sixth switch, and the eighth switch are conducted, turning off the second switch, the fourth switch, the fifth switch, and the seventh switch, so that the current path passes sequentially from the input end through the first switch, the capacitor, and the third switch to the end of the output capacitor, and passes sequentially from the another end of the output capacitor through the eighth switch, the flying capacitor, and the sixth switch to the output end.
